(19) United States
(12) Patent Application Publication
(10) Pub. No.: US 2009/0308946 A1
(43) Pub. Date: Dec. 17, 2009

(54) Aerosol Can Adaptor for Spraying Equipment

(76) Inventors: James A. Dube, Assonet, MA (US); Matthew A. Campbell, S. Weymouth, MA (US); Michael C. Flanagan, Wareham, MA (US); Michael N. Atwater, Salem, NH (US); Keith D. Begin, Rockland, MA (US)

Correspondence Address: WHYTE HIRSCHBOECK DUDEK S.C.;INTELLECTUAL PROPERTY DEPARTMENT, 555 E. WELLS ST., SUITE 1900, MILWAUKEE, WI, 53202, US

(21) Appl. No.: 12/136,974

(22) Filed: Jun. 11, 2008

(51) Int. Cl. A62C 5/02

(52) U.S. Cl. 239/9

(57) ABSTRACT

A system is provided for spraying a material, the system comprising: a canister having a first threaded fitting in fluid communication with a valve seal; a dip tube extending from the valve seal into the canister; an adaptor having a second threaded fitting that mates with the threads of the first threaded fitting and an adaptor tube; and, a nozzle in fluid communication with the adaptor; wherein the adaptor tube interacts with the valve seal to move the valve into an open position, thereby establishing a continuous flow path from the canister to the nozzle through the dip tube, valve seal and adaptor tube.

### FIELD OF THE INVENTION

The present invention relates to spray systems for applying a sprayable compound and more specifically, to an adaptor for combining an aerosol canister with other spray equipment.

### BACKGROUND

Historically, fluid delivery has been provided by pumps, siphons, propellants, aerosols, mechanical force, compressed gases, hydraulic devices and even gravity. Sophisticated spray nozzles, have been engineered that deliver precise delivery rates and patterns. Complete coverage is necessary for paints, fungicides, bactericides, insecticides, fertilizers, sealants, mastics, adhesives, lubricants, waterproofing compounds, waxes, cleaners and the like to guarantee optimum protection of the underlying valuable substrate. Uniformity of coverage is desirable for esthetic, economic and consistency reasons. Moreover, different substrates have unique requirements for coverage thickness, effective dose or balance of utility and appearance so it is desirable for a spraying system to be adjustable.

At the same time, the marketplace is demanding smoother coating surfaces, more thorough coverage, more uniform coverage, the ability to handle new materials, more ergonomic delivery systems, environmentally friendly propellants, less waste, more application flexibility, shorter or no cleaning times and reduced setup time. Ergonomics, convenience, environmental considerations and quality have also been driving the development of spray systems technology.

Pumps are able to consistently deliver precise amounts of liquids at easy-to-regulate rates but suffer from a lack of portability. Pumps have gotten smaller and lighter but ultimately were replaced with compressed air, used with pressure pots. Nonetheless, the compressed air hose has a finite weight that increases with the distance between the compressed air source and the spraying job. Several companies have introduced canisters into the marketplace that can be pressurized with one propellant charge at the point of manufacture that suffices to discharge the entire canister contents while maintaining an acceptable spray pattern and eliminating most of the hose. While the canister is portable and can be transported up ladders and down stairways far from sources of electricity and compressed air, the contents of the canister must still be carried. A typical canister has an approximate gross weight of 60 pounds.

Portability and ease of cleaning are a major advantage of canisters over pressure pots. Pressure pots must be taken apart after each use and all hoses and needle valves scrupulously cleaned to avoid clogging on startup. Canisters need only be put away; no cleaning between uses is generally necessary. Some cleanup is involved when changing canisters. Deployment of hoses and cords is often awkward and time-consuming; users of canisters have only the hose to the spray gun to maneuver.

It is wasteful and, in some areas, illegal to discard large canisters after a single use but the end user is. not always in a position to return reusable canisters. Insurance companies are making it more expensive for manufacturers to purchase and store flammable materials. Many of the propellants used in canisters and aerosol spray cans are flammable so there is significant motivation to use water-based and nonflammable systems. Recent patents by Hammarth, et al, (U.S. Pat. No. 6,848,599 and U.S. Pat. No. 6,905,084) describe a canister system for water-based adhesives that has no flammable solvents and uses no flammable propellants. Likewise, environmental regulations are severely curtailing the use of methylene chloride in many locations and toxicity issues are being raised with other solvents as well. It is obviously preferable for propellants to be nonflammable and nontoxic but it is also desirable to exclude the so-called greenhouse gases such as carbon dioxide. While it is not the intent to limit the scope of this invention to water-based formulations, there are aspects of the invention that will address some of the deficiencies these environmentally-friendly systems and thereby encourage their use.

Canisters are charged with enough propellant at the time of manufacture to enable efficient discharge of canister contents without exceeding the Department of Transportation limit on shippable pressure (260 psi at 130° F.). Consequently, canister pressure decreases as the canister is emptied resulting in some spray pattern variability, splattering on startup and the like. Empirical evidence suggest that higher viscosity liquids can be sprayed from aerosol cans than from canisters. Aerosol cans are more portable, can be brought more easily into confined spaces and provide more consistent pressure as the contents of the can are used. Aerosols would also make it easier to change colors, mix two-part systems or spray narrower bands without waste.

### BRIEF DESCRIPTION OF THE DRAWINGS

FIG. 1 is a cross-sectional side view of a typical prior art aerosol spray can;

FIG. 2 is a side view of an embodiment of the invention in which an air hose and spray gun are attached to an adaptor mounted on an aerosol can having a threaded mount;

FIG. 3 is a side view of an embodiment of the invention in which a spray gun is close mounted to an adaptor mounted on an aerosol can having a threaded mount;

FIG. 4 is a schematic view of the adaptor of the invention;

FIG. 5 is a cross-sectional view of the adaptor of FIG. 4 mounted on an aerosol can;

FIG. 6 is a side view of a holster of the invention; and

FIG. 7 is a side schematic view of a manifold of the invention.

### DESCRIPTION

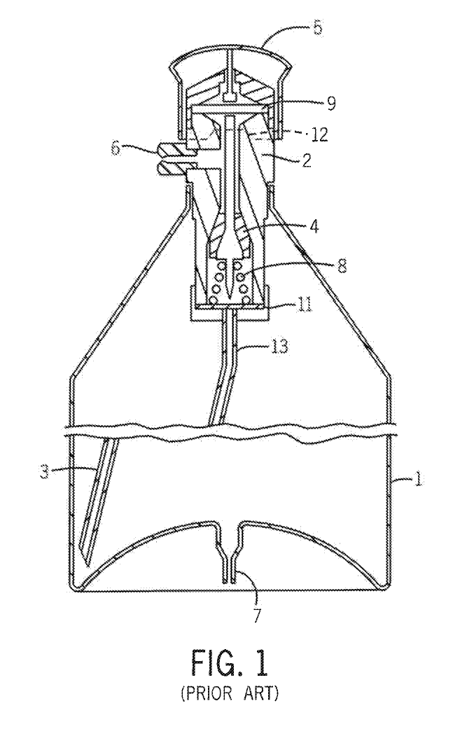

As shown in FIG. 1, the typical prior art aerosol can, as described in U.S. Pat. No. 1,800,156, consists of a rolled steel crimped cylinder with a circular pressed and crimped bottom and a pressed and crimped top with a tab-activated pressure release valve assembly. In FIG. 1 a bottle or container 1 constructed of any suitable material is provided with a valve casing 2 with ascending pipe 3, valve 4, pressure knob 5 and ejector 6. The bottom of the bottle which may for example consist of brass is provided with a short pipe 7 to be used for filling the bottle under pressure. This pipe can be closed by compression and it may be by soldering when the bottle has been filled. The valve is kept in place besides by the action of the inner pressure also by a spring 8. The reference number 9 designates an elastic diaphragm consisting for example of rubber. The valve body has a pointed end 10, which can penetrate a staniol disk 11 by the first use of the bottle. The lower edge of the pressure knob has a recess 12 fitting over the ejector 6. Only when the pressure knob has been turned so as to place the said recess over the ejector the pressure knob can be operated so as to influence the valve. In other positions the pressure knob will thus lock the valve. The ejector thus operates not only as spraying orifice but also as a stop. 13 is an opening from the ascending pipe 3 to the gas space in the bottle.

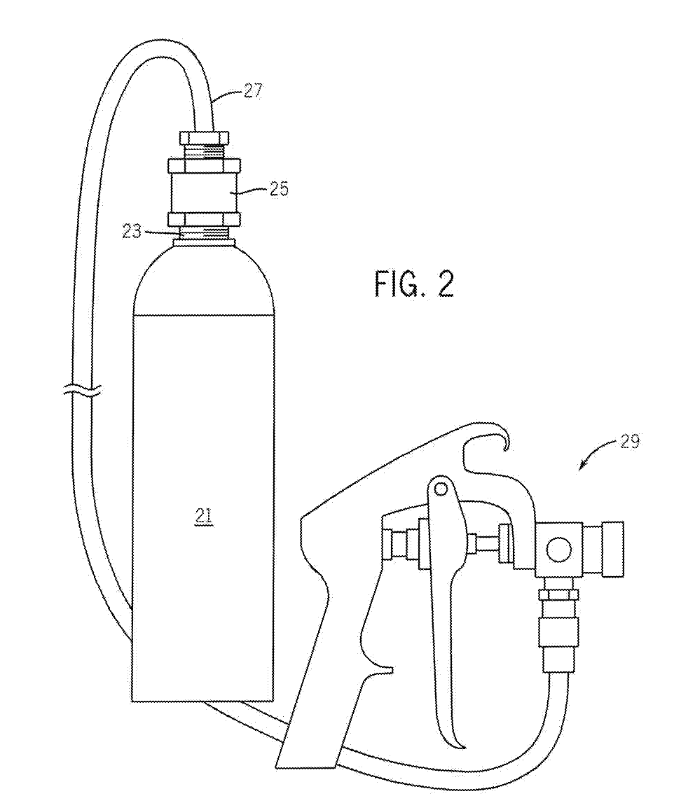

As shown in FIG. 2, the present invention comprises an aerosol can 21 equipped with threaded valves 23. An adaptor 25 is connected to the threaded valves 23. Also connected to the adaptor 25 is an air hose 27 that provides a flow channel to a spray nozzle. The spray nozzle may be of any desired design, but conveniently may be a spray gun 29 as shown. For convenience, the invention will be described in terms of a spray gun 29, but any suitable equivalent spray device may be substituted and still be within the scope of this invention. The adaptor 25 activates or opens the threaded valves 23 to allow release of the contents from the aerosol can 21. The adaptor 25 further provides fluid communication between the opened threaded valves 23 and the air hose 27. Accordingly, in the inventive system control over material flow from the aerosol can is effectively transferred from the threaded valve 23 to the spray gun 29.

Threaded valves are now being produced for aerosol cans by Newman-Green, Inc. of Addison, Ill. Unlike the traditional smooth pedestal valves, the threaded valves can accommodate fittings and adapters. Moreover, a process has been developed by DS Containers of Batavia, Ill. that enables the inside of the aerosol cans to be lined with a protective polymer that prevents water from attacking the metal.

The hose material can be rubbery (SBR, nitrile, polyisoprene, natural rubber, butyl, polychloroprene, or copolymers or mixtures or the like) or polymeric (polycarbonate, polyethylene, nylon, vinyl acetate, acrylic, polypropylene, copolymers or mixtures or the like) depending on chemical resistance, pH, temperature or flexibility requirements.

The spray gun 29 can be chosen from any one of a variety of designs for water- or solvent-based formulations depending on chemical compatibility or on desired spray pattern.

Some manufacturers of aerosol nozzles have provided spray adjustment capabilities but these are crude at best. A spray gun allows fluid flow adjustments by using an adjustable restriction at the discharge. In addition, the two afore-mentioned Hammarth patents (U.S. Pat. No. 6,848,599 and U.S. Pat. No. 6,905,084) describe a gun for water-based systems that enables the end user to clear the tip when the valve is closed, thus eliminating the nozzle-clogging problems inherent in aerosol cans. The increased adjustability of the spray gun over the aerosol nozzle is useful when, for example, the end user needs to switch coverage from a broad area to a narrow strip. The ability to narrow the fan width setting on the fly allows the transition with minimal waste. A volume adjustment is desirable to maintain even coating rates when the substrate absorption rate changes as so often happens with wood grain. Changes in application temperature and in aerosol can pressure can drastically alter the spray pattern and it is very convenient in demanding applications if the aerosolizing pressure can be fine-tuned by metering fluid flow using a restriction at the discharge site.

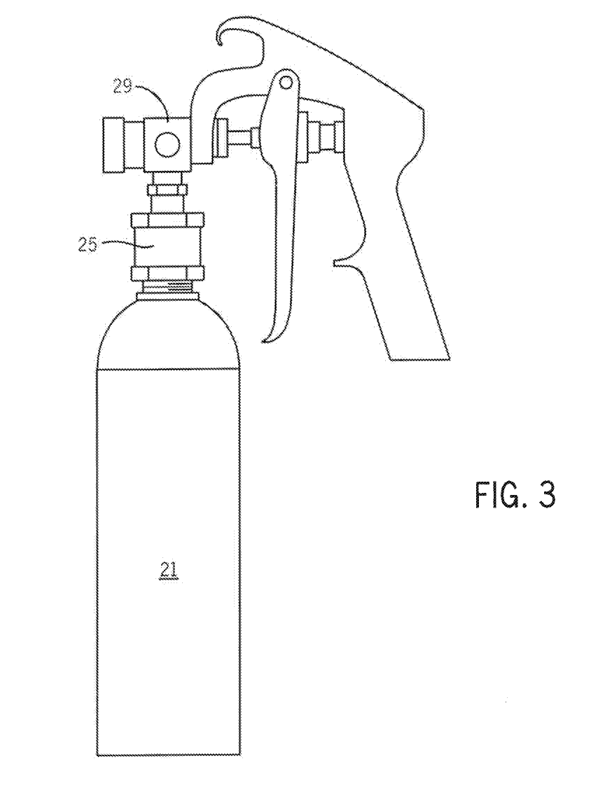

In another embodiment, shown in FIG. 3, the air hose 27 is eliminated and the spray gun 29 is directly coupled to the adaptor 25.

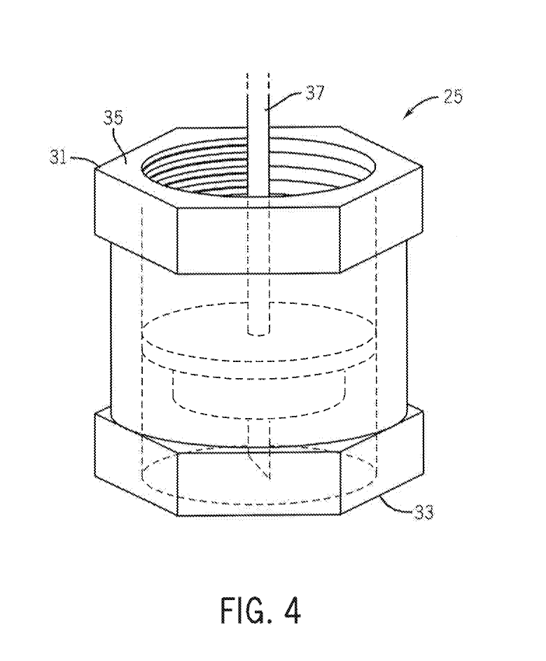

The adaptor 25 of this invention is shown in FIG. 4. The adaptor 25 has connection means on the proximate end to attach to the aerosol can and on the distal end to attach to the spray gun or air hose. In one embodiment, the adaptor 25 is made by drilling out a metal rod 31 and threading and tapping it to accommodate the valve thread on the proximate end 31 and the hose connection/spray gun on the distal end 33. Seated in the center of this rod is a metal tube 37 that serves two purposes. The first is to open the valve on the aerosol can.

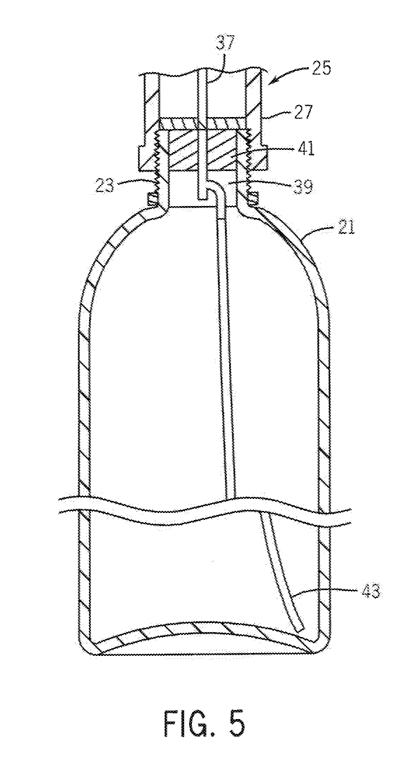

As shown in FIG. 5 as the aerosol can 21 is screwed into the adaptor 25, the metal tube 37 makes contact with the top of the aerosol can's valve 39, thus forcing the valve into the valve seat, thereby opening the valve. This action then opens the fluid path through the metal tube, fulfilling its second function as a conduit. The metal rod 37 and tube 39 can variously be comprised of aluminum, steel, stainless steel or the like depending on the requirements of the formulation in the can. In a similar fashion, the design and composition of the hose and spray gun can be chosen based on the chemical and spray pattern requirements of the can contents.

A male tab 41 must be provided for the tapped end of the adapter 25 that connects with the threaded aerosol can 21 valve system in order to depress the valve 39 and allow egress of the can contents. The threading 23 allows the end user to easily change cans while using the same spray gun without interruption. The valve and tab assembly permits cans to be changed without the messy leaks that sometimes occur when canisters need changing. An additional advantage is that it is easier and more ergonomic to transport the few aerosol cans needed to do the job than to move around even the smallest available canister (11-pounder).

A dip tube 43 is attached to the valve 39 of the aerosol can 21 that extends to the bottom of the can enabling removal of most of the fluid. The propellant that is added is not soluble in the fluid and rises to the upper part of the can, If the can is turned upside down, and the nozzle pressed, propellant is rapidly expelled, having risen to the new “top” of the can where the dip tube can conduct it out of the container, This technique is recommended to clear a blocked nozzle but if too much propellant is used up in this fashion, there will not be enough left to empty the can and some of the active ingredient will be wasted. An effective limit is thus placed on the effective spraying angle for the aerosol can, Loss of propellant is overcome with the present invention by attaching a hose with a spray gun to the aerosol can; the can is maintained in the vertical position and the spray gun can moved to the desired spray angle and sprayed without propellant depletion.

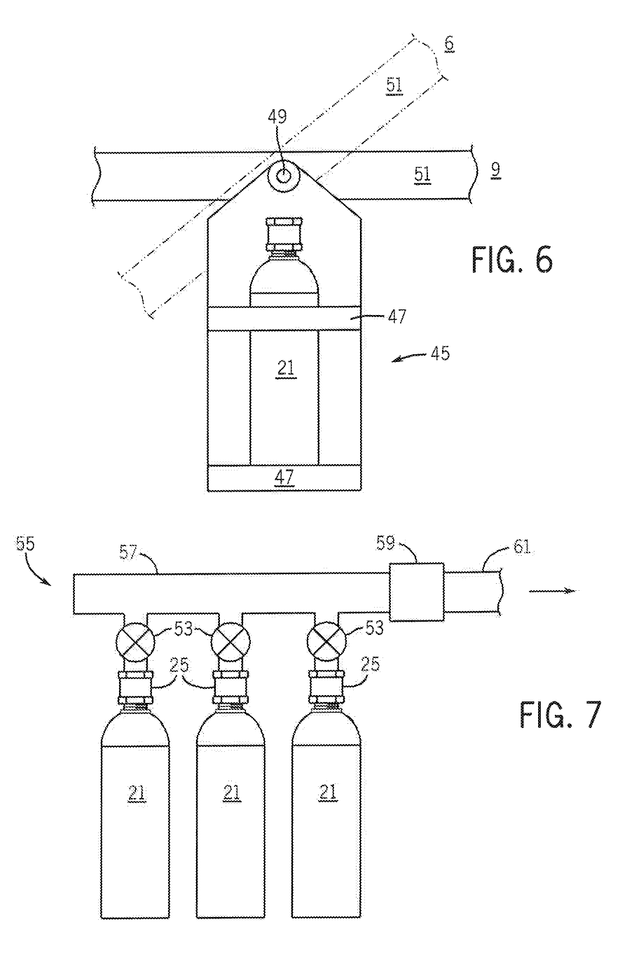

As shown in FIG. 6, the aerosol can 21 may be placed in a pivoting holster 45 that can be attached to the end user's belt 51. Holster 45 typically will have restraining elements 47 to hold an aerosol can 21 in place. Restraining elements 47 may be any suitable device such as s strap, a clip, a brace, etc. Holster 45 attaches to a carrying device, such as a user's belt 51. The connection between the holster 45 and user's belt 51 is a pivot 49. Holster 45 may freely rotate around pivot 49. As such, holster 45 can maintain an upright position both when the belt 51 is a horizontal position A, as well as in a skewed position B, as shown in FIG. 6. Thus, the can is guaranteed to always be in a vertical position, no matter what contortions the end user must undergo to complete the spray job. This simple expedient not only secures the aerosol can but prevents unwanted loss of propellant if the can deviates substantially from the vertical.

In some embodiments, the invention includes a lightweight manifold system 55 (mountable on the end user's belt) that accommodates several aerosol cans 21 at once. Such a manifold system 55 is shown in FIG. 7. A number of aerosol cans 21 are each mounted on a separate adaptor 25. Each adaptor 25 communicates with a manifold 57. Typically, the manifold 57 is a tube closed on one end and having a connector 59 on the other end. Connector 59 allows connection to a spray hose nozzle or spray gun 61. Conveniently, a valve 53 is mounted between the adaptor 25 and the manifold 57. Valve 53 allows for the flow from aerosol can 21 to the manifold 57 to be selectively turned on and off, thereby allowing the user to select which can or cans should be applied. Valves 53 can also be used, if desired, with any other embodiment of this invention. Any suitable shut off valve, such as a turn cock, gate, butterfly valve, etc. may be used.

In one example, the cans 21 might contain different paint colors and a cleaning solution. A painter using several colors on a wall mural could, using valves in the manifolds, switch back and forth among colors. This operation would be very tedious if a different canister was needed for each color—extra cleaning and waste would be costly and time-consuming.

Certain water-based adhesives can be induced to dry faster (reducing part assembly cycle time) by coagulating the adhesive in place using a salt solution. In a practical sense, the adhesive is first sprayed on the substrate, then, in a second operation, the salt solution is applied. With the adhesive and salt solution threaded into the manifold, this procedure could be accomplished with the same equipment in a single operation simply by throwing manifold valves. A cleaning solution could be used at the end to prevent cross-contamination.

It is often desirable to prepare a stronger coating by reacting two substrates in order to, for example, form a crosslink. Unfortunately, the two reactants cannot usually be stored together without drastically reducing shelf life so the operation must be carried out in a more labor-intensive two-step process. The success of the two-step process is not only dependent upon the accuracy of the ratios of the reactants but also on the completeness of mixing them. The variability is often too much for the average end user to deal with and results are not likely to be satisfactory. With a manifold system 55, the two reactants can be introduced in a single step at nearly the same pressure; static in-line mixers (not shown) can control the degree of homogeneity and a satisfactory coating experience is more likely to occur.

Although the system described above can be applied to both solvent- and water-based formulations, the highest, most desirable use is for water-based systems that are nonflammable and have less toxic solvent systems. Metal containers corrode in the presence of water either yielding rust that clogs the needle valves and small diameter orifices or coagulating the latex which accomplishes the same undesirable result. Some manufacturers have used corrosion inhibitors to overcome this problem but these additives can adversely affect the desired end properties of the coating. Moreover, corrosion inhibitors do not stop corrosion, they merely postpone it. The Hammarth patents (U.S. Pat. No. 6,848,599 and U.S. Pat. No. 6,905,084) introduce the concept of a bag in a canister to overcome corrosion, but such a system adds considerable expense and complexity to the smaller aerosol containers. Fortunately, aerosol cans that are lined with polymer are being currently being manufactured by DS Containers of Batavia, Ill.

The practical advantage is that higher viscosity formulations can be sprayed from an aerosol can than from a canister. The practical upper viscosity limit for sprayability from a canister is about 600 cP but formulations having viscosities of over 1000 cP have been sprayed from the spray system described in the current invention at a lower pressure. Thus, the invention increases the viscosity of formulations that are sprayable. Furthermore, use of a lower pressure means that more shear sensitive formulations can now be sprayed. The end result is that more products can be sprayed.

### EXAMPLES

The following examples are given as illustrations only and do not limit the applicability of the invention in any way.

### Example 1

A manifold with 3 aerosol cans containing a water-based contact adhesive and 1 aerosol can containing a cleaning solution is attached to an airless spray gun via a hose section. A particle board countertop and corresponding high pressure laminate (HPL) are sprayed with contact adhesive at the recommended application rate, switching aerosol cans using valves as cans empty. The spray gun fan width is decreased and the countertop edges and HPL edge pieces are sprayed without stopping. The cleaning solution is engaged to clean the lines prior to a time of inactivity.

### Example 2

Ductwork located in a crowded attic must be sprayed. A manifold with 3 aerosol cans containing a water-based duct sealant and 1 aerosol can containing a cleaning solution is attached to an airless spray gun via a hose section. The spray gun is manipulated around the duct to spray the recommended amount of duct sealant on the appropriate duct joints. The valves on the manifold are used to switch to full aerosol cans as needed. When the 3 cans are all empty, new cans are easily installed on the manifold without the need for cleanup. The belt holster maintains the aerosol cans in a vertical configuration so there is no loss of propellant. The cleaning solution is engaged to clean the lines prior to a time of inactivity.

### Example 3

Three aerosol cans containing Behr latex paint (viscosity 3000 cP) are attached to a manifold along with 1 aerosol can containing cleaning solution. The ceiling is painted using the spray gun attached to the manifold with a hose. At the end of the painting, minimal cleanup is necessary unlike the tedious, time-consuming cleaning necessary for commercial paint sprayers such as the Wagner system. As always, the cleaning solution can be used to clean the lines prior to a time of inactivity.

### Example 4

The valved manifold is charged with 3 aerosol cans containing 3 different insecticides and 1 aerosol can with cleaning solution. The homeowner is free to choose the insecticide appropriate for ornamentals, garden vegetable or fruit trees from the assortment on the manifold simply by throwing the right valves. The assembly is lightweight and requires no water hose to be dragged around, nor does the operation have to be re-started for every insecticide change.

### Example 5

A water-based contact adhesive in an aerosol can at 130 psi is sprayed to emptiness using the hose and spray gun of the present invention. The corresponding canister requires 200 psi to spray to emptiness. An aerosol can containing cleaning solution is used to flush the line and the spray gun at the end of the job.

### Example 6

A water-based duct liner adhesive (7000 cP) in an aerosol can is attached to a hose and a spray gun. The duct work is sprayed with the recommended adhesive level, changing cans when necessary. An aerosol can containing cleaning solution is used to flush the line and the spray gun at the end of the job. Spraying can be started and stopped until the aerosol can is empty.

### Comparative Example 1

A water-based duct liner adhesive (7000 cP) in a canister is attached to a hose and a spray gun. Initially, spraying goes well, but eventually stops when the high viscosity causes line blockage that is difficult, if not impossible to clear.

We claim:

1. A system for spraying a material, the system comprising:
a canister having a first threaded fitting in fluid communication with a valve seal;
a dip tube extending from the valve seal into the canister;
an adaptor having a second threaded fitting that mates with the threads of the first threaded fitting and an adaptor tube; and,
a nozzle in fluid communication with the adaptor;
wherein the adaptor tube interacts with the valve seal to move the valve into an open position, thereby establishing a continuous flow path from the canister to the nozzle through the dip tube, valve seal and adaptor tube.

2. The system of claim 1, further comprising at least one valve located between the adapter tube and the nozzle, the valve operable to selectively open and close the continuous flow path.

3. The system of claim 2, further comprising a spray gun, the spray gun comprising the nozzle and at least one valve.

4. The system of claim 3, further comprising a hose between the adapter and the spray gun, wherein the continuous flow path passes through the hose.

5. The system of claim 1, characterized in that the canister contains a liquid and a propellant, wherein the dip tube extends into the liquid when the canister is in an upright position.

6. The system of claim 1, wherein the liquid is selected from adhesives, paints, coatings, epoxies, and cleaning fluids.

7. A manifold for selectively spraying multiple liquids, the manifold comprising:
multiple canisters, the canisters comprising a first threaded fitting in fluid communication with a valve seal, a dip tube extending from the valve seal into the canister, and an adaptor having a second threaded fitting that mates with the threads of the first threaded fitting and an adaptor tube, wherein the adaptor tube interacts with the valve seal to move the valve into an open position;
a central flow conduit in fluid communication with a spray nozzle;
a first valve between the central flow conduit and the nozzle, the first valve operable to control flow through the nozzle; and,
at least one branch conduit for each canister, the branch conduit providing fluid communication between the adaptor tube and the central flow conduit, each branch conduit comprising a second valve, the second valve operable to control flow between the canister and the central conduit,
wherein the adaptor tube interacts with the valve seal to move the valve into an open position, thereby establishing a continuous flow path from the canister to the nozzle through the dip tube, valve seal and adaptor tube.

8. The manifold of claim 7, further comprising a spray gun, the spray gun comprising the nozzle and the first valve.

9. The manifold of claim 8, further comprising a hose between the central flow conduit and the spray gun, wherein the continuous flow path passes through the hose.

10. The manifold of claim 9, characterized in that the canister contains a liquid and a propellant, wherein the dip tube extends into the liquid when the canister is in an upright position.

11. The manifold of claim 10, wherein the liquid is selected from adhesives, paints, coatings, epoxies, and cleaning fluids.

12. The manifold of claim 7, further comprising a holster, the holster comprising a receptacle adapted for receiving the canisters, means for attaching the holster to a belt or other clothing, the means for attachment comprising a pivot, wherein the receptacle rotates around the pivot such that the canisters are maintained in an upright position.

13. A method for applying a multiple component compound, comprising:
loading a manifold with canisters such that at least one canister containing each component is loaded into the manifold, wherein the manifold comprises:
multiple canisters, the canisters comprising a first threaded fitting in fluid communication with a valve seal, a dip tube extending from the valve seal into the canister, and an adaptor having a second threaded fitting that mates with the threads of the first threaded fitting and an adaptor tube, wherein the adaptor tube interacts with the valve seal to move the valve into an open position;
a central flow conduit in fluid communication with a spray nozzle;
a first valve between the central flow conduit and the nozzle, the first valve operable to control flow through the nozzle; and,
at least one branch conduit for each canister, the branch conduit providing fluid communication between the adaptor tube and the central flow conduit, each branch conduit comprising a second valve, the second valve operable to control flow between the canister and the central conduit,
wherein the adaptor tube interacts with the valve seal to move the valve into an open position, thereby establishing a continuous flow path from the canister to the nozzle through the dip tube, valve seal and adaptor tube;
opening the second valve for at least one canister of each component of the multiple component compound; and,
opening the first valve to permit flow through the nozzle.

14. The method of claim 13, further comprising installing a static mixer in the central flow conduit or between the central flow conduit and the nozzle.

15. A method for applying a multiple separate compounds, comprising:
loading a manifold with canisters such that at least one canister containing each separate compound is loaded into the manifold, wherein the manifold comprises:
multiple canisters, the canisters comprising a first threaded fitting in fluid communication with a valve seal, a dip tube extending from the valve seal into the canister, and an adaptor having a second threaded fitting that mates with the threads of the first threaded fitting and an adaptor tube, wherein the adaptor tube interacts with the valve seal to move the valve into an open position;
a central flow conduit in fluid communication with a spray nozzle;
a first valve between the central flow conduit and the nozzle, the first valve operable to control flow through the nozzle; and,
at least one branch conduit for each canister, the branch conduit providing fluid communication between the adaptor tube and the central flow conduit, each branch conduit comprising a second valve, the second valve operable to control flow between the canister and the central conduit,
wherein the adaptor tube interacts with the valve seal to move the valve into an open position, thereby establishing a continuous flow path from the canister to the nozzle through the dip tube, valve seal and adaptor tube;
opening the second valve for at least one canister of a first one of the separate compounds;
selectively opening and closing the first valve to selectively permit flow through the nozzle;
closing the second valve for the canister of the first one of the separate compounds;
opening the second valve for a canister of a second one of the separate compounds; and,
opening the first valve to permit flow through the nozzle.

16. The method of claim 15 further comprising passing a cleaning fluid through the central flow conduit and nozzle after a second valve is closed.

17. A method for cleaning a spray manifold, comprising:
loading the manifold with at least one canister containing a compound to be sprayed, wherein the manifold comprises:
multiple canisters, the canisters comprising a first threaded fitting in fluid communication with a valve seal, a dip tube extending from the valve seal into the canister, and an adaptor having a second threaded fitting that mates with the threads of the first threaded fitting and an adaptor tube, wherein the adaptor tube interacts with the valve seal to move the valve into an open position;
a central flow conduit in fluid communication with a spray nozzle;
a first valve between the central flow conduit and the nozzle, the first valve operable to control flow through the nozzle; and,
at least one branch conduit for each canister, the branch conduit providing fluid communication between the adaptor tube and the central flow conduit, each branch conduit comprising a second valve, the second valve operable to control flow between the canister and the central conduit,
wherein the adaptor tube interacts with the valve seal to move the valve into an open position, thereby establishing a continuous flow path from the canister to the nozzle through the dip tube, valve seal and adaptor tube;
loading the manifold with a canister containing a cleaning fluid;
opening the second valve for at least one canister of the compound to be sprayed;
selectively opening and closing the first valve to selectively permit flow through the nozzle;
closing the second valve for the canister of the compound to be sprayed;
opening the second valve for a canister of the cleaning fluid; and,
opening the first valve to permit flow through the nozzle.
